(19) United States
(12) Patent Application Publication
(10) Pub. No.: US 2023/0190550 A1
(43) Pub. Date: Jun. 22, 2023

(54) Wheelchair Cover

(71) Applicant: Alene Smith, Pinellas Park, FL (US)

(72) Inventor: Alene Smith, Pinellas Park, FL (US)

(21) Appl. No.: 18/067,478

(22) Filed: Dec. 16, 2022

Related U.S. Application Data
(60) Provisional application No. 63/290,513, filed on Dec. 16, 2021.

(51) Int. Cl. A61G 5/10

(52) U.S. Cl. CPC A61G 5/10

(57) ABSTRACT

A wheelchair cover includes a covering member and a securing means. The covering member comprises a seat portion, a back portion, a first armrest portion, and a second armrest portion. The seat portion is configured to cover at least a portion of a seat of a wheelchair. The back portion is configured to cover at least a portion of a backrest of the wheelchair. The first armrest portion is configured to cover at least a portion of a first armrest of the wheelchair. The second armrest portion is configured to cover at least a portion of a second armrest of the wheelchair. The covering member further comprises a rim, and the securing means is attached to the rim of the covering member to secure covering member to the wheelchair.

### FIELD OF THE INVENTION

The present invention relates generally to wheelchair covers. More specifically, the present invention is a disposable cover for wheelchairs. The present invention is specifically designed for wheelchairs. However, the present invention is not limited to this option, and it may further be adapted for different purposes.

### BACKGROUND OF THE INVENTION

Within the health industry there a variety of different patients are usually seen by the same healthcare professionals where the same equipment is utilized for everyone. When various individuals utilize the same equipment, the chances for spreading bacteria, viruses and pathogens increase greatly. As patients are pushed around in a wheelchair, the patient interacts and touches the wheelchair handles and seats that are then touched by other patients and healthcare professionals. Many hospitals and healthcare offices attempt to mitigate the risk of spreading diseases from the wheelchairs by either disinfecting the equipment after each use or by having one wheelchair per patient or client. Both of these methods for mitigating risk come with the disadvantage of having to take time to properly disinfect each wheelchair or needing a large inventory of wheelchairs to accommodate each patient or client.

Therefore, it is an objective of the present invention to provide a wheelchair cover which overcomes the problems set forth above.

### SUMMARY OF THE INVENTION

The present invention discloses a wheelchair cover that comprises a covering member and a securing means. The covering member comprises a seat portion, a back portion, a first armrest portion, and a second armrest portion. The seat portion is configured to cover at least a portion of a seat of a wheelchair. The back portion is configured to cover at least a portion of a backrest of the wheelchair. The first armrest portion is configured to cover at least a portion of a first armrest of the wheelchair. The second armrest portion is configured to cover at least a portion of a second armrest of the wheelchair. The covering member further comprises a rim, and the securing means is attached to the rim of the covering member to secure covering member to the wheelchair.

In one embodiment, the covering member further comprises a first end and a second end, and the second end is greater than the first end in width. Preferably, the first end is adjacent to the back portion of the covering member, and the second end is adjacent to the seat portion of the covering member.

In one embodiment, the covering member is made of liquid impermeable plastic film. In a preferred embodiment, the covering member is made of polypropylene.

In another embodiment, the covering member is made of liquid impermeable paper material.

In another embodiment, the covering member is made of liquid impermeable cloth fabric.

In one embodiment, the securing means comprises an elastic band circumferentially attached to the rim of the covering member

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of a preferred embodiment of a wheelchair cover in accordance with one or more aspects of the present invention, wherein the wheelchair cover is secured onto a wheelchair.

FIG. 2 depicts another perspective view of the wheelchair cover of the present invention, wherein the wheelchair cover is secured onto a wheelchair.

FIG. 3 depicts yet another perspective view of the wheelchair cover of the present invention, wherein the wheelchair cover is secured onto a wheelchair.

FIG. 4 depicts a top view of the wheelchair cover of the present invention prior to use.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of wheelchair covers, embodiments of the present disclosure are not limited to use only in this context.

The present invention is a wheelchair cover that is specifically designed to wheelchairs. It is an aim of the present invention to provide a cover that is lightweight, easy to use, and environmentally friendly. It is another aim of the present invention to provide a disposable wheelchair cover to reduce the spread of viruses, bacteria and pathogens. It is yet another aim of the present invention to allow a user to conveniently secure the cover to the wheelchair.

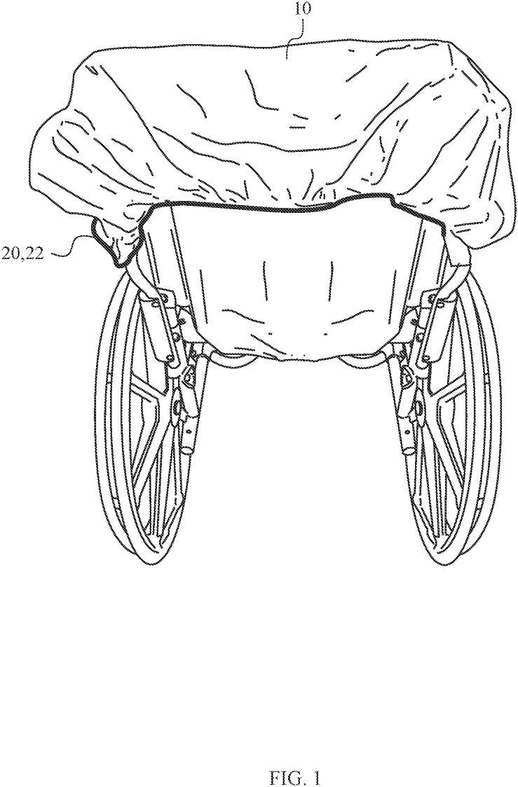

Referring now to the figures of the present disclosure. FIG. 1 is a perspective view of a preferred embodiment of a wheelchair cover in accordance with one or more aspects of the present invention. The wheelchair cover of the present invention comprises a covering member 10 and a securing means 20.

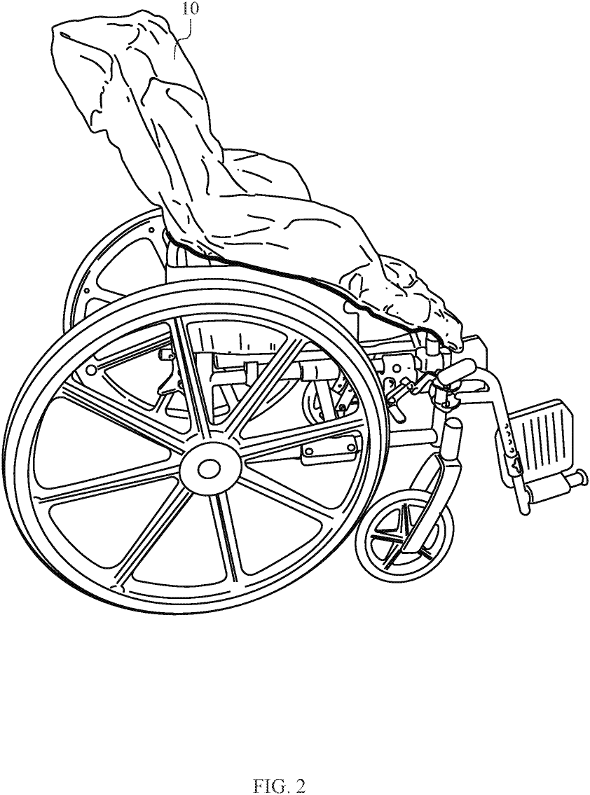

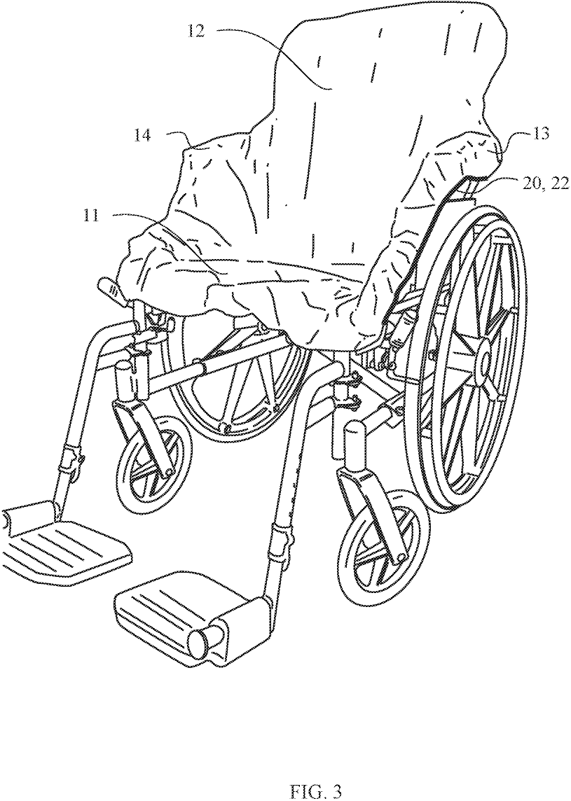

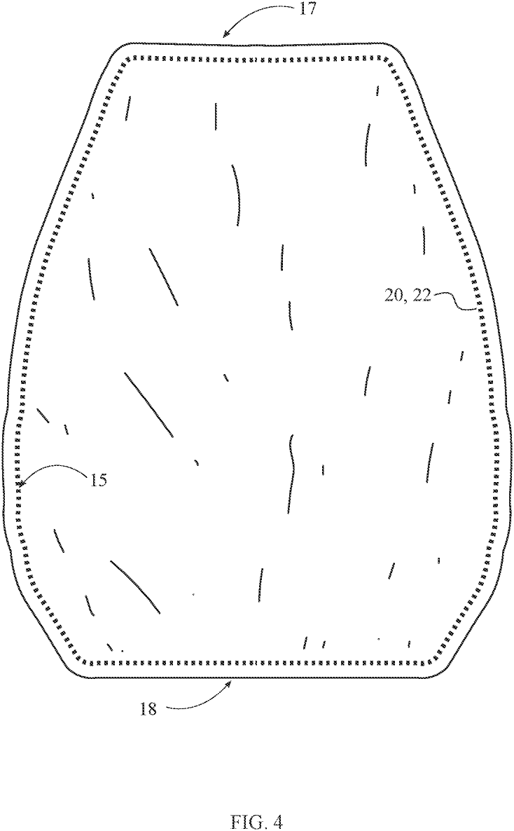

In reference to FIGS. 1-5, the covering member 10 is configured to be fitted onto a wheelchair. It should be noted that the covering member 10 can be of any shape, size, material, features, type or kind, orientation, location, quantity, components, and arrangements of components that would allow the present invention to fulfill the objectives and intents of the present invention. In one embodiment, the covering member 10 comprises a seat portion 11, a back portion 12, a first armrest portion 13, and a second armrest portion 14. The seat portion 11 is configured to cover at least a portion of a seat of a wheelchair. Therefore, the seat portion 11 has a front to back dimension that is at least equal to the depth of the seat of the wheelchair and a side-to-side width dimension which is at least equal to the width of the seat of the wheelchair. The back portion 12 configured to cover at least a portion of a backrest of the wheelchair. Moreover, the first armrest portion 13 is configured to cover at least a portion of a first armrest of the wheelchair, while the second armrest portion 14 is configured to cover at least a portion of a second armrest of the wheelchair. In other words, the first armrest portion 13 and the second armrest portion 14 cover the left and right armrest of the wheelchair respectively.

In reference to FIG. 5, the covering member 10 may comprise a first end 17 and a second end 18. The first end 17 is adjacent to the back portion 12 of the covering member 10, and the second end 18 is adjacent to the seat portion 11 of the covering member 10. In a preferred embodiment, the second end 18 is greater than the first end 17 in width.

The covering member 10 may be made of any suitable material. In one embodiment, the covering member 10 may be made of liquid impermeable plastic film, preferably, polypropylene. In another embodiment, the covering member 10 may be made of liquid impermeable paper material. In yet another embodiment, the covering member 10 may be made of liquid impermeable cloth fabric.

The covering member 10 further comprises a rim 15, as best shown in FIG. 5. The securing means 20 is attached to the rim 15 of the covering member 10 to secure covering member 10 to the wheelchair. It should also be noted that the securing means 20 can be of any shape, size, material, features, type or kind, orientation, location, quantity, components, and arrangements of components that would allow the present invention to fulfill the objectives and intents of the present invention. In a preferred embodiment, the securing means 20 comprises an elastic band 22 circumferentially attached to the rim 15 of the covering member 10. The elastic band 22 of the present invention ensures a convenient connection to the wheelchair. Thus, the present invention is disposable wheelchair cover that can be easily secured to and removed from a wheelchair to conveniently and properly protect healthcare workers and various patients that utilize the wheelchair. The elastic band 22 may be made of a stretchy material with a ¼ inch thickness to allow the covering member to snugly fit around the wheelchair. The elastic band 22 also ensures that the covering member has no hanging part to keep it away from the moving parts of the wheelchair.

In one embodiment, multiple wheelchair covers as described above may be provided in a sealed packaging appointed to house the wheelchair covers prior to use in a clean environment. Furthermore, it is envisioned that the sizes of the components forming the present invention such as the seat portion 11, the back portion 12, the first armrest portion 13, and the second armrest portion 14 can vary based on design requirements. Moreover, the wheelchair cover of the present invention may be available in different sizes to fit to dimensions of different available wheelchairs.

Although the disclosure has been explained in relation to its preferred embodiment, it is to be understood that many other possible modifications and variations can be made without departing from the spirit and scope of the disclosure.

What is claimed is:

1. A wheelchair cover comprising:
a covering member;
a securing means;
the covering member comprising a seat portion, a back portion, a first armrest portion, and a second armrest portion;
the seat portion being configured to cover at least a portion of a seat of a wheelchair;
the back portion being configured to cover at least a portion of a backrest of the wheelchair;
the first armrest portion being configured to cover at least a portion of a first armrest of the wheelchair;
the second armrest portion being configured to cover at least a portion of a second armrest of the wheelchair;
the covering member further comprising a rim; and
the securing means being attached to the rim of the covering member to secure covering member to the wheelchair.

2. The wheelchair cover as claimed in claim 1, wherein the covering member further comprises a first end and a second end, and the second end is greater than the first end in width.

3. The wheelchair cover as claimed in claim 2, wherein the first end is adjacent to the back portion of the covering member, and the second end is adjacent to the seat portion of the covering member.

4. The wheelchair cover as claimed in claim 1, wherein the covering member is made of liquid impermeable plastic film.

5. The wheelchair cover as claimed in claim 4, wherein the covering member is made of polypropylene.

6. The wheelchair cover as claimed in claim 1, wherein the covering member is made of liquid impermeable paper material.

7. The wheelchair cover as claimed in claim 1, wherein the covering member is made of liquid impermeable cloth fabric.

8. The wheelchair cover as claimed in claim 1, wherein the securing means comprises an elastic band circumferentially attached to the rim of the covering member.

9. A wheelchair cover comprising:
a covering member;
a securing means;
the covering member comprising a seat portion, a back portion, a first armrest portion, and a second armrest portion;
the seat portion being configured to cover at least a portion of a seat of a wheelchair;
the back portion being configured to cover at least a portion of a backrest of the wheelchair;
the first armrest portion being configured to cover at least a portion of a first armrest of the wheelchair;
the second armrest portion being configured to cover at least a portion of a second armrest of the wheelchair;
the covering member further comprising a rim;
the securing means being attached to the rim of the covering member to secure covering member to the wheelchair;
the covering member further comprising a first end and a second end;
the first end being adjacent to the back portion of the covering member;
the second end being adjacent to the seat portion of the covering member;
the second end being greater than the first end in width; and
the covering member being made of liquid impermeable plastic film.

10. The wheelchair cover as claimed in claim 9, wherein the covering member is made of polypropylene.

11. The wheelchair cover as claimed in claim 9, wherein the securing means comprises an elastic band circumferentially attached to the rim of the covering member.

12. A wheelchair cover comprising:
a covering member;
a securing means;
the covering member comprising a seat portion, a back portion, a first armrest portion, and a second armrest portion;
the seat portion being configured to cover at least a portion of a seat of a wheelchair;
the back portion being configured to cover at least a portion of a backrest of the wheelchair;
the first armrest portion being configured to cover at least a portion of a first armrest of the wheelchair;
the second armrest portion being configured to cover at least a portion of a second armrest of the wheelchair;
the covering member further comprising a rim;
the securing means being attached to the rim of the covering member to secure covering member to the wheelchair;
the covering member being made of polypropylene; and
the securing means comprising an elastic band circumferentially attached to the rim of the covering member.

13. The wheelchair cover as claimed in claim 12, wherein the covering member further comprises a first end and a second end, and the second end is greater than the first end in width.

14. The wheelchair cover as claimed in claim 13, wherein the first end is adjacent to the back portion of the covering member, and the second end is adjacent to the seat portion of the covering member.
